(19) United States
(12) Patent Application Publication
(10) Pub. No.: US 2012/0199432 A1
(43) Pub. Date: Aug. 9, 2012

(54) Brake transmission mechanism in a brake lever of bicycle

(76) Inventor: Szu-Fang Tsai, Changhua (TW)

(21) Appl. No.: 13/411,624

(22) Filed: Mar. 4, 2012

(30) Foreign Application Priority Data
Feb. 8, 2011 (TW) 101202258

(51) Int. Cl. B62L 3/02

(52) U.S. Cl. 188/344

(57) ABSTRACT

A brake operating device for bicycle is provided a housing mounted on a handlebar and including a channel; a hydraulic brake lever pivotably secured to the housing and including an push member at one end, the push member including a cavity; a brake transmission mechanism disposed in the channel and comprising a stepped-diameter piston including an annular first groove distal the cavity, an annular second groove proximate the cavity, an intermediate groove, a resilient ring member put on the first groove, a return spring biasing against one end of the piston, an O-ring sealingly put on the second groove, and a flat surface at the other end facing the cavity; and an actuating member rotatably contacting both the cavity and the flat surface.

### BACKGROUND OF THE INVENTION

1. Field of the Invention

The invention relates to bicycle brake and more particularly to a brake transmission mechanism in a brake lever of bicycle with improved characteristics.

2. Description of Related Art

A conventional brake operating device for bicycles comprises a housing mounted in the vicinity of a grip (not shown) of a handlebar (not shown), a hydraulic brake lever rotatably supported on the housing through a cylindrical, stepped diameter pivot provided through two opposite holes spaced by a bifurcated opening, a fluid reservoir (not numbered) disposed in the housing, and a reservoir cover releasably secured to the fluid reservoir.

The conventional brake operating device further comprises a spring actuated brake transmission mechanism provided in a cylindrical channel in the housing. The brake transmission mechanism comprises a stepped-diameter piston in a hydraulic cylinder (not shown) which communicates brake fluid with the fluid reservoir, the piston including two annular end grooves and an annular intermediate groove, two opposite ring members put on the end grooves, a return spring biasing between one end of the piston and an inner surface of the hydraulic cylinder, a hydraulic line (not shown) having one end connected to the cylinder and the other end passing the channel to a hydraulic disc brake (not shown), and a threaded push rod having one end pushing the piston via a C-ring and a washer. A threaded fastener having one end engaged with the other end of the push rod and the other end disposed in one of three portions of a tunnel of T cross-section in the brake lever is provided.

The conventional brake operating device further comprises two retaining members fitted in the remaining two portions of the tunnel respectively in a spaced manner. A stepped-diameter pivot has one end fitted in one retaining member, the other end fitted in the other retaining member, and an intermediate portion engaged with the other end of the fastener.

In a braking operation, a rider may press the brake lever toward the grip to pivot about the pivot. And in turn, the pivot pushes the fastener which in turn presses the push rod. As a result, a wheel brake is actuated via the brake transmission mechanism, the brake fluid in the fluid reservoir, and other associated components known in the art.

However, a number of drawbacks have been found in the conventional brake operating device. For example, the brake transmission mechanism has excess components which are subjected to malfunction. Further, its manufacturing cost is higher. Furthermore, its braking operation is not smooth. Thus, the need for improvement still exists.

### SUMMARY OF THE INVENTION

It is therefore one object of the invention to provide a brake operating device for a bicycle, comprising a housing mounted on a handlebar and comprising a channel; a hydraulic brake lever pivotably secured to the housing and comprising an push member at one end, the push member including a cavity; a brake transmission mechanism disposed in the channel and comprising a stepped-diameter piston including an annular first groove distal the cavity, an annular second groove proximate the cavity, an intermediate groove, a resilient ring member put on the first groove, a return spring biasing against one end of the piston, an O-ring sealingly put on the second groove, and a flat surface at the other end facing the cavity; and an actuating member rotatably contacting both the cavity and the flat surface.

The above and other objects, features and advantages of the invention will become apparent from the following detailed description taken with the accompanying drawings.

### BRIEF DESCRIPTION OF THE DRAWINGS

FIG. 1 is an exploded view of a brake operating device for a bicycle according to the invention in which an actuating member of a first preferred embodiment is shown;

FIG. 2 is a perspective view showing the actuating member of FIG. 2 mounted in the socket and the actuating member to be engaged with the piston;

FIG. 3 is a view similar to FIG. 2 showing an actuating member of a second preferred embodiment mounted in the socket and the actuating member to be engaged with the piston;

FIG. 4 is a side elevation showing the piston and the steel ball mounted in both the brake lever and the housing;

FIG. 5 is a view similar to FIG. 4 showing a brake being actuated by pressing the brake lever and cooperation of the steel ball, the piston, and other associated members;

FIG. 6 is an exploded view of the piston;

FIG. 7 is a perspective view of the assembled piston; and

FIG. 8 is a longitudinal sectional view of the piston of FIG. 7.

### DETAILED DESCRIPTION OF THE INVENTION

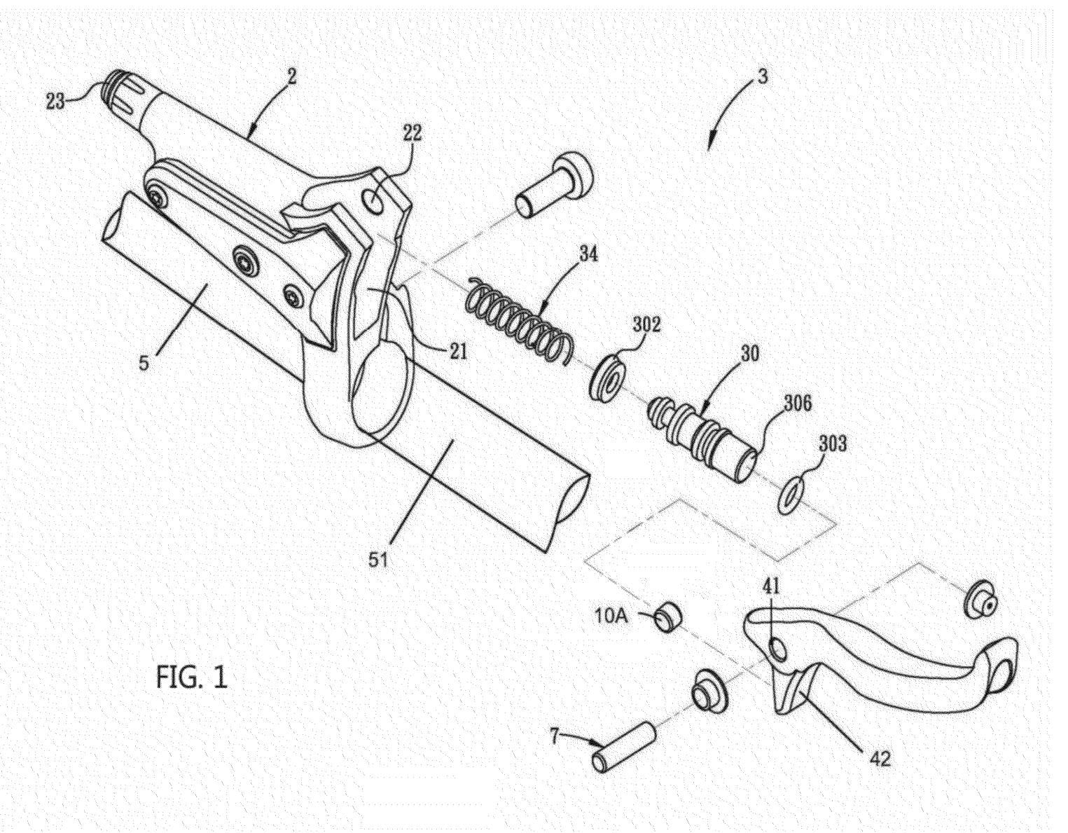

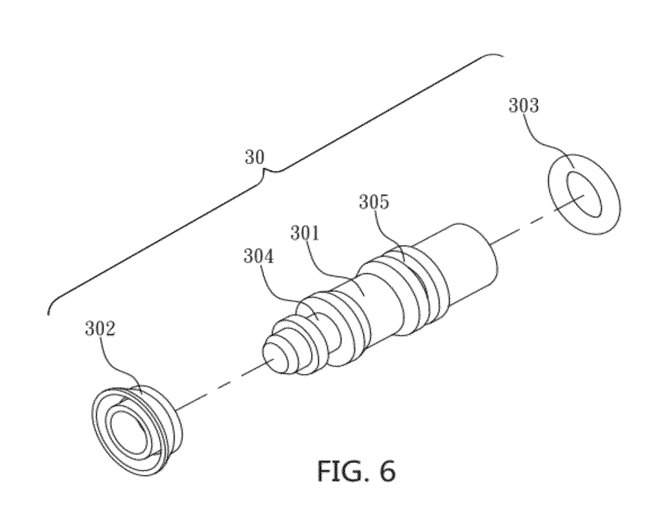

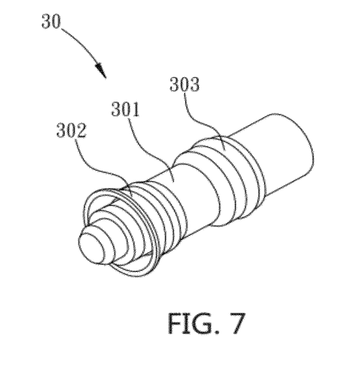

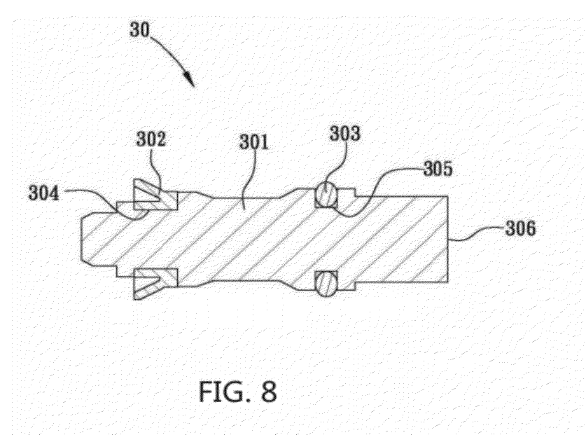

Referring to FIGS. 1 to 8, a brake operating device for a bicycle incorporating a brake transmission mechanism in accordance with the invention is shown.

The brake operating device comprises a housing 2 mounted in the vicinity of a grip 51 of a handlebar 5, a hydraulic brake lever 4, a fluid reservoir (not shown) disposed in the housing 2, and a reservoir cover (not numbered) releasably secured to the fluid reservoir.

The conventional brake operating device further comprises a brake transmission mechanism 3 provided in a cylindrical channel 23 in the housing 2. The brake transmission mechanism 3 comprises a stepped-diameter piston 30 in a hydraulic cylinder (not shown) which communicates brake fluid with the fluid reservoir, the piston 30 including an annular first groove 304 distal the brake lever 4, an annular second groove 305 proximate the brake lever 4, an intermediate groove 301, a resilient ring member 302 put on the first groove 304, a return spring 34 biasing between one end of the piston 33 and an inner surface of the hydraulic cylinder, a hydraulic line (not shown) having one end connected to the hydraulic cylinder and the other end passing the channel 23 to a hydraulic disc brake (not shown), an O-ring 303 sealingly put on the second groove 305, and a flat surface 306 at the other end proximate the brake lever 4.

Both depth and width of the first groove 304 are greater than that of the second groove 305. Radius of the ring member 302 is greater than that of the O-ring 303. Thus, the ring member 302 resiliently engages the inner surface of the hydraulic cylinder for effecting a smooth back and forth movement of the piston 30. The intermediate groove 301 has a depth less that of each of the first and second grooves 304 and 305.

The brake lever 4 comprises a channel 41 at one end. A pivot 7 is provided through two opposite holes 22 spaced by a bifurcated opening 21 and the channel 41 disposed in the opening 21 so as to rotatably support the brake lever 4 on the housing 2.

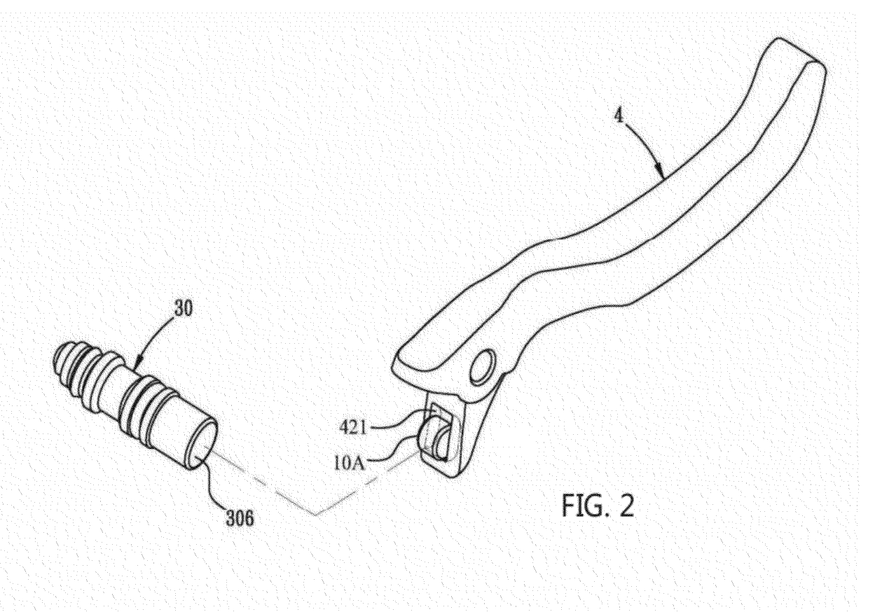

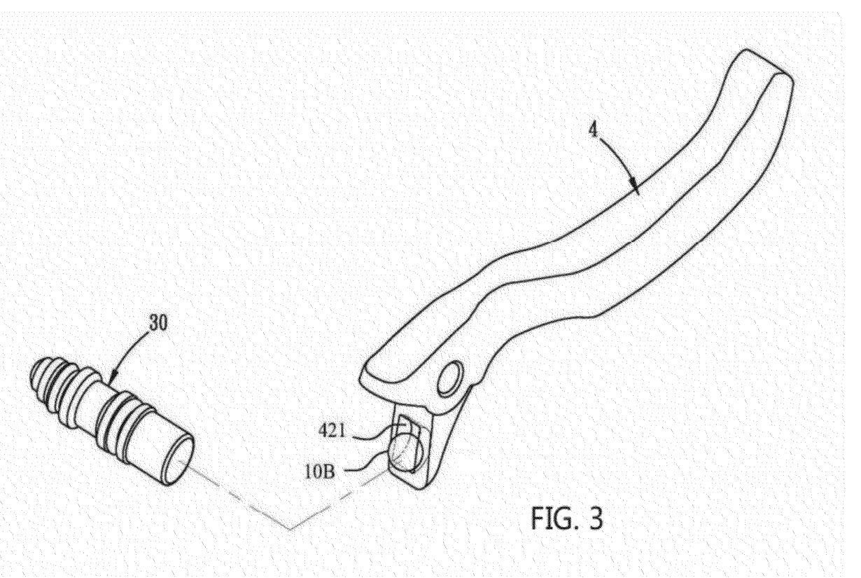

The brake lever 4 further comprises a push member 42 projecting out of a surface position near the tunnel 41. The push member 42 includes a cavity 421A facing the flat surface 306, the cavity 421 being shaped as a cup having a flared mouth. In a first preferred embodiment, an actuating member is implemented as a short cylinder 10A (see FIGS. 1 and 2). The cylinder 10A rotatably contacts both the cavity 421 and the opposite flat surface 306. In a second preferred embodiment, the actuating member is implemented as a steel ball 10B (see FIGS. 3-5). Also, the steel ball 10B rotatably contacts both the cavity 421 and the opposite flat surface 306.

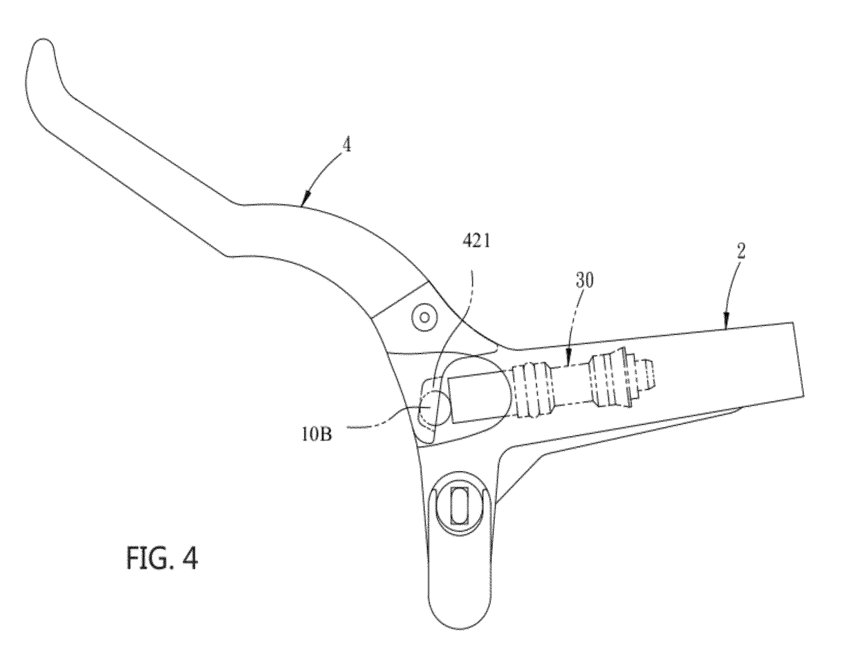

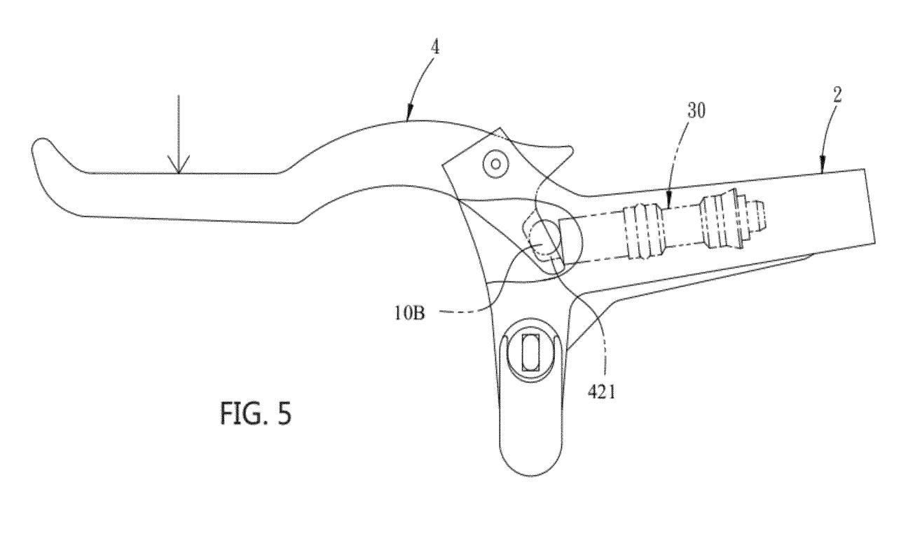

In a braking operation as shown in FIGS. 4 and 5, a rider may press the brake lever 4 toward the grip 51 to pivot about the pivot 7. And in turn, the push member 42 pivots to push the piston 30 further into the housing 2 via the steel ball 10B (as an exemplary example). As a result, a wheel brake is actuated via the brake transmission mechanism 3, the brake fluid in the fluid reservoir, and other associated components known in the art.

It is envisaged by the invention that the provision of the actuating member can compensate any rough braking operations that may occur.

While the invention has been described in terms of preferred embodiments, those skilled in the art will recognize that the invention can be practiced with modifications within the spirit and scope of the appended claims.

What is claimed is:

1. A brake operating device for a bicycle, comprising:
a housing mounted on a handlebar and comprising a channel;
a hydraulic brake lever pivotably secured to the housing and comprising an push member at one end, the push member including a cavity;
a brake transmission mechanism disposed in the channel and comprising a stepped-diameter piston including an annular first groove distal the cavity, an annular second groove proximate the cavity, an intermediate groove, a resilient ring member put on the first groove, a return spring biasing against one end of the piston, an O-ring sealingly put on the second groove, and a flat surface at the other end facing the cavity; and
an actuating member rotatably contacting both the cavity and the flat surface.

2. The brake operating device of claim 1, wherein the actuating member is a cylinder.

3. The brake operating device of claim 1, wherein the actuating member is a steel ball.

4. The brake operating device of claim 1, wherein both depth and width of the first groove are greater than that of the second groove.

5. The brake operating device of claim 1, wherein radius of the ring member is greater than that of the O-ring.

6. The brake operating device of claim 1, wherein depth of the intermediate groove is less that of each of the first and second grooves.
